(19) United States
(12) Patent Application Publication
(10) Pub. No.: US 2026/0085985 A1
(43) Pub. Date: Mar. 26, 2026

(54) TESTING PROBE FOR A HAPTIC DEVICE

(71) Applicant: Boréas Technologies Inc., Bromont (CA)

(72) Inventors: LouisDavid ARCHAMBAULT, Bromont (CA); Cedric LECLERC, Bromont (CA); Mathilde CHARMEAU, Bromont (CA)

(21) Appl. No.: 19/110,930

(22) PCT Filed: Sep. 11, 2023
(86) PCT No.: PCT/CA2023/051203

§ 371 Date: Mar. 12, 2025

Related U.S. Application Data
(60) Provisional application No. 63/375,295, filed on Sep. 12, 2022.

(51) Int. Cl. G01L 1/16; G01L 5/22

(52) U.S. Cl. CPC G01L 1/16; G01L 5/22

(57) ABSTRACT

Inconclusive and inconsistent results from existing haptic testing systems, e.g. for trackpads, which include rigidly mounted resistive load cells and accelerometers, prevent accurate results, especially in a high-volume production context. The use of a rigidly mounted sensor is unsuitable because a trackpad will generally be softer than the actuation system, whereby, when the haptic event is fired, the vast majority of the energy will be lost in the trackpad, while the sensor remains almost stationary. Accordingly, an improved test probe for a haptic device configured for mounting on a robotic arm, comprises: a contact tip configured for contacting the haptic device; a sensor configured for measuring a threshold force of the piezoelectric actuator device, and an haptic characteristic, e.g. acceleration, of a resulting haptic response thereof at a same time and a same location; and a compliant element configured for enabling the sensor to move relative to the haptic device.

### TECHNICAL FIELD

The present disclosure relates to a testing probe for a haptic device, e.g. a haptic trackpad with a piezoelectric actuator, and in particular to a testing probe for testing both forces, e.g. to trigger a response, applied to the haptic device and haptic responses, e.g. forces or acceleration, resulting from the haptic actuator device at the same location at a same time.

### BACKGROUND

Haptic devices, such as haptic trackpads with piezoelectric actuators, may be used to replace buttons in electronic devices. Applying a force to a haptic device greater than a threshold activation force can be detected by control electronics, which will trigger a haptic effect or response. A command, e.g. voltage, signal can then be sent to the haptic device to produce haptic feedback to let the user know the action has been performed.

There are multiple advantages to use haptic devices, e.g. piezo-electric actuators, as a replacement for traditional switches, e.g. haptic devices can have the ability to detect different force thresholds instead of simple on/off states, and they can produce a variety of haptic feedbacks, e.g. clicks, buzz, complex waveforms, etc., to enrich the user experience. Haptic devices may have some limitations and a challenge to characterize, e.g. the amount of displacement they can produce or be subjected to is often small when compared to their variation of height as compared to traditional switches and feedback devices. Existing measurement systems, such as probes, rigidly mounted impedance heads, resistive load cells and accelerometers, often result in inconclusive and inconsistent results, and experience has shown that none of these solutions were robust or simple enough to be used in a production context for high volume measurements.

The use of a rigidly mounted sensor is unsuitable, simply because a trackpad will generally be much softer than the rigidly mounted sensor. Consequently, when the haptic event is fired, the vast majority of the haptic effect will be lost, while the sensor remains almost stationary.

An object of the present disclosure is to provide a test probe to enable threshold force and haptic response measurements for a haptic device, e.g. a trackpad with a piezo-electric actuator, to be tested at the same time and location.

### SUMMARY

Accordingly, a first apparatus includes a test probe for a haptic device configured for mounting on a moveable structure, comprising: a contact tip configured for contacting the haptic device; a sensor configured for measuring a threshold force of the haptic device, and a haptic response characteristic of a resulting of a haptic feedback response from the haptic device, at substantially a same time and substantially a same location; a compliant element configured for enabling the sensor to move relative to the haptic device; and a mounting member configured for mounting the testing probe on the moveable structure. Ideally, the compliant member provides the test probe with a mechanical impedance close to a human finger.

In any of the above embodiments, the first apparatus may also include that the sensor comprises an impedance head capable of measuring both force and acceleration or a resistive load cell configured for measuring the threshold force, and a piezoelectric sensor element configured for measuring the haptic response characteristic.

In any of the above embodiments, the compliant element may include an elastomeric disc with a stiffness of between 1 N/mm to 10 N/mm.

In any of the above embodiments, the compliant element may be an elastomeric disc that may be sandwiched between first and second interface plates.

In any of the above embodiments, the compliant element may have a damping property of between 0.5 Ns/m to 1 Ns/m.

In any of the above embodiments, the haptic characteristic may be selected from the group consisting of strength of the haptic effect, duration, force, displacement, derivatives of displacement, and frequency.

In any of the above embodiments, the haptic characteristic may be displacement, velocity or acceleration.

In any of the above embodiments, the system may further comprise a set of compliant element sections, some with one or more different properties, selected from the group consisting of mass, spring constant, and dampening, configured for adjusting the mass, the spring constant, and the dampening properties of the compliant element to enable specific haptic behaviors to be captured.

Accordingly, a second apparatus includes a testing system for a haptic device, comprising: a moveable structure; a test probe configured for mounting on the moveable structure; a controller processor; and a non-transitory memory storing instructions, which when executed by the controller processor direct the test probe to contact the haptic device. The probe comprising: a contact tip configured for contacting the haptic device; a sensor configured for measuring a threshold force of the haptic device, and a haptic response characteristic of a resulting haptic response thereof at a same time and a same location; and a compliant element configured for enabling the sensor to move relative to the haptic device.

In any of the above embodiments, the controller processor may direct the test probe to move at least 1 mm/s.

In any of the above embodiments, the controller processor may direct the test probe to move between 0.5 mm/s and 15 mm/s.

In any of the above embodiments, the controller processor may convert electrical signals from the sensor into corresponding force and haptic response characteristic measurements; and the controller processor may add a force offset to the force measurement, and add a haptic response characteristic offset to the haptic response characteristic measurement.

In any of the above embodiments, the controller may determine the force offset and the haptic response characteristic offset based on experimental data from independent fixed force and haptic response characteristic sensors.

In any of the above embodiments, the sensor may comprise an impedance head configured for measuring both force and acceleration simultaneously or a resistive load cell configured for measuring the threshold force, and a piezoelectric sensor element configured for measuring the haptic response characteristic.

In any of the above embodiments, the compliant element may include an elastomeric disc with a stiffness of between 1 N/mm to 10 N/mm.

In any of the above embodiments, the compliant element may be sandwiched between first and second interface plates.

In any of the above embodiments, the compliant element may have a damping property of between 0.5 Ns/m to 1 Ns/m.

In any of the above embodiments, the haptic characteristic may be selected from the group consisting of strength of the haptic effect, duration, and frequency.

In any of the above embodiments, the haptic characteristic may be displacement, derivatives of displacement, or frequency.

In any of the above embodiments, the test system may further comprise a set of compliant element sections, some with one or more different properties, selected from the group consisting of mass, spring constant, and dampening, configured for adjusting the mass, the spring constant, and the dampening properties of the compliant element to enable specific haptic behaviors to be captured.

### BRIEF DESCRIPTION OF THE DRAWINGS

Some example embodiments will be described in greater detail with reference to the accompanying drawings, wherein:

FIG. 1A is an isometric view in accordance with an example of a test probe for a haptic device;

FIG. 1B is an isometric view in accordance with an example of a test probe for a haptic device;

FIG. 1C is a cross-sectional view of an example of a test probe for a haptic device;

FIG. 2 is a perspective view of a testing system including the test probe of FIG. 1;

FIG. 3A is a side view of the test probe of FIG. 1;

FIG. 3B is a top view of the test probe of FIG. 1;

FIG. 4 is a cross-sectional view of the test probe of FIG. 1; and

FIG. 5 is a flow chart of a method of determining offsets for the test probe of FIG. 1.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

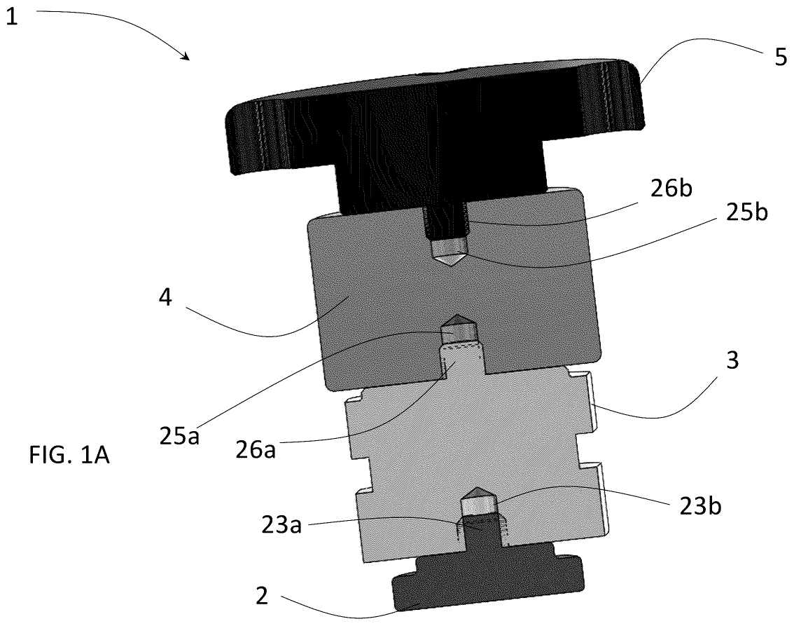

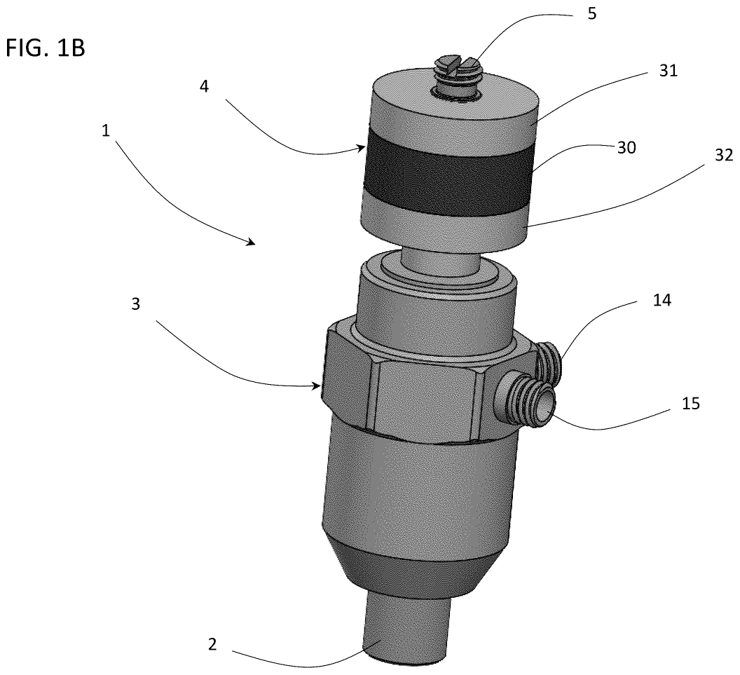

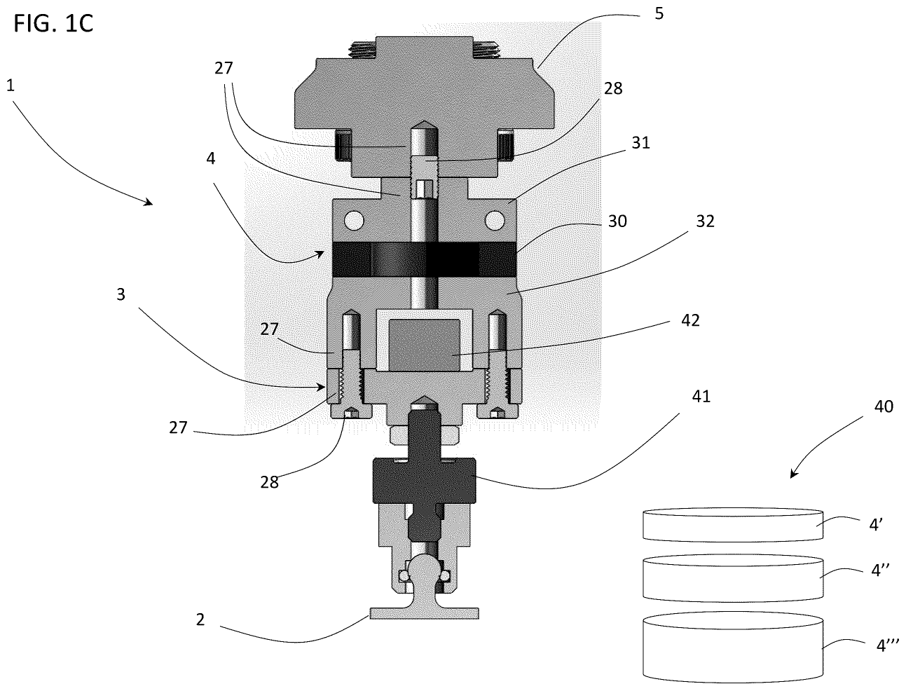

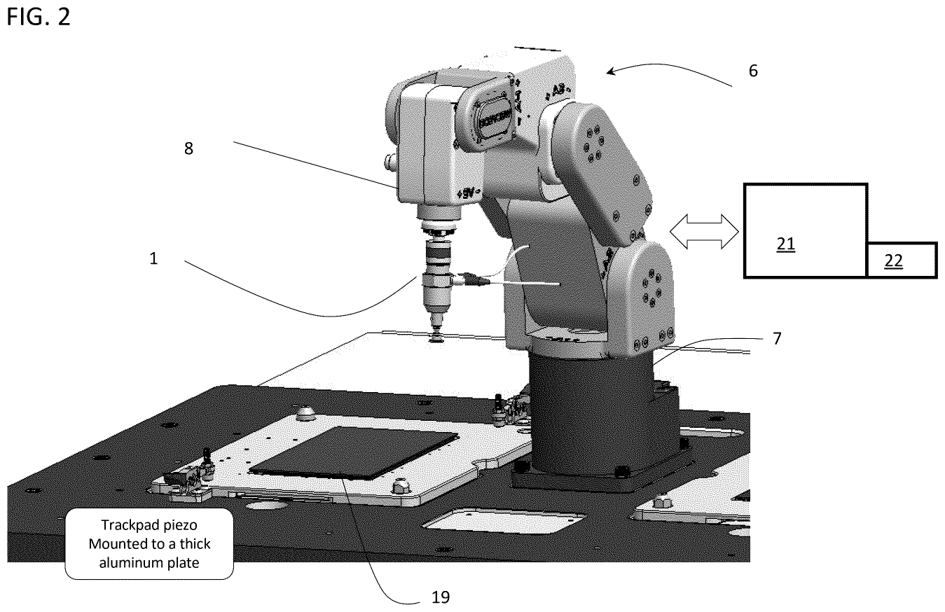

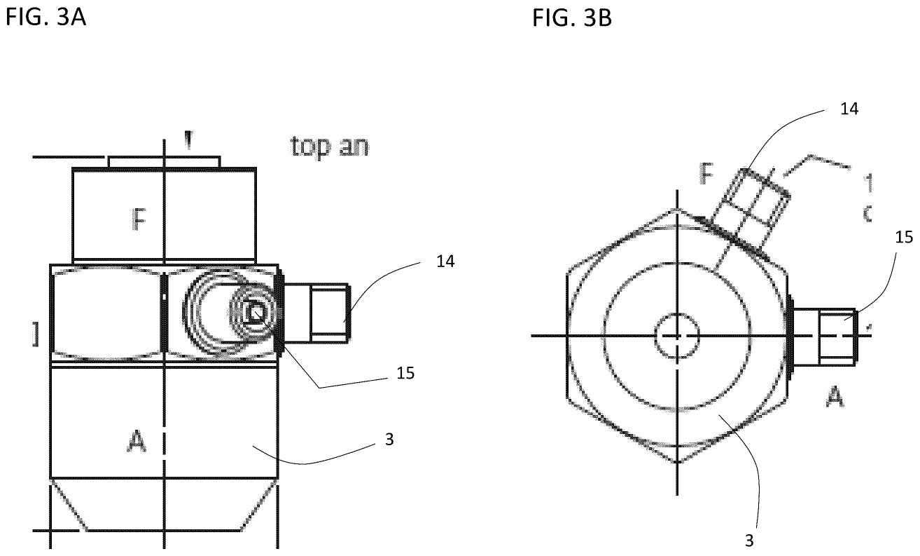

With reference to FIGS. 1A, 1B and 1C, a testing probe 1 for a haptic device, such as a trackpad with a piezoelectric actuator, comprises a contact tip 2 extending outwardly from one end thereof, measuring sensors 3, such as a force and acceleration sensor, a compliant element 4, and a mounting member 5 configured for mounting the testing probe 1 on the end of a moveable structure 6 providing one or multiple axes of orientation and movement, such as a robotic arm 8 of an actuator 7 (FIG. 3). The robotic arm 8 and the actuator 7 may be under manual control or under control of a controller processor 21 executing computer instructions saved on a non-transitory memory 22.

The measuring sensors 3 may be configured to measure both force, e.g. force threshold to actuate the haptic effect, and a characteristic of the resulting haptic effect, e.g. strength of the haptic effect, displacement, acceleration, force, duration, velocity and frequency, at substantially the same time and location, i.e. excluding latency and jitter. In some embodiments, e.g. FIG. 1B, the measuring sensors 3 may include an impedance head, such as an off-the-shelf sensor, e.g. a Kistler 8770ATM. Conventional impedance heads, e.g. the Kistler sensor 8770ATM, are intended to be fixed to a structure to perform modal analysis on that structure. The impedance head is essentially a piezoelectric ceramic element that is compressed and stretched as the impedance head moves up and down, causing a change in voltage at the leads of the ceramic. The change in voltage corresponds to a known acceleration value. In other words, the impedance head measures acceleration of the sensor itself, therefore if the sensor cannot move, there will be no acceleration. In some embodiments, e.g. FIG. 1C, the measuring sensors 3 may include a resistive load cell 41 configured for measuring force, e.g. force threshold to actuate the haptic effect, and a piezoelectric sensor 42, e.g. accelerometer, configured for measuring a characteristic of the resulting haptic effect, e.g. strength of the haptic effect, displacement, (and its derivatives, e.g. velocity and acceleration), force, duration, and frequency, at substantially the same time and location, i.e. excluding latency and jitter. The moving section of the test probe 1, i.e. everything below the compliant element 4, e.g. the measuring sensors 3, the contact tip 2, and the bottom interface plate 32, is configured to have a predetermined desired mass. To obtain a mechanical impedance close to the one of a human finger, the mass of the moving section of the test probe 1 should be as small as possible, preferably between 4 and 20 grams. Moreover, as for the example FIG. 1B, the compliant element 4 is serviceable, and can be removed, changed or modified as needed without changing the other components of the probe 1.

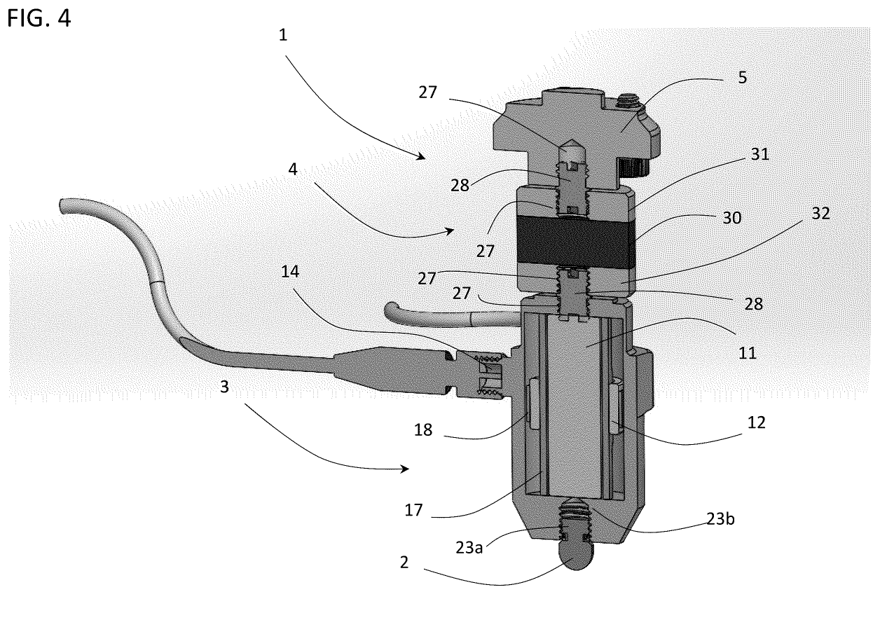

With reference to FIGS. 3A, 3B, and 4, each impedance head may include two piezoelectric sensor elements, i.e. a first piezoelectric sensor element 11 for measuring force and a second piezoelectric sensor element 12 for measuring acceleration, but other embodiments are within the scope of the invention. Each of the first and second piezoelectric sensor elements 11 and 12 may be internally connected to one or more microelectronic circuits that converts the charge signals from the first and second piezoelectric sensor elements 11 and 12 into useable first and second high level voltage signals, respectively, for transmission via first and second low impedance outputs 14 and 15 to an external controller processor for storage, compilation and conversion into human readable form. In the illustrated exemplary embodiment, the first piezoelectric sensor element 11 comprises an elongated piezoelectric structure extending between opposite top and bottom surfaces of the sensor 3 for recording electrical signals corresponding to the force applied by the probe 1 on the test subject. The second piezoelectric sensor element 12 comprises an annular piezoelectric structure held between a frame 17, e.g. a hollow cylindrical body, at least partially surrounding the first piezoelectric sensor element 11, and a ring 18 shrink fit around the annular piezoelectric structure. The annular piezoelectric structure of the second piezoelectric sensor element 12 gets sheared by reciprocating movement of the sensor 3, resulting in shear forces between the annular piezoelectric structure of the second piezoelectric element 12 and the frame 17, thereby generating an electrical signal corresponding to the acceleration thereof.

To measure a haptic event generated by a touch interface, for example a trackpad 19 including one or more piezoelectric actuators, the probe 1 may be used as a finger configured for pressing on the trackpad 19 and registering the resulting trackpad behavior, i.e. the force, e.g. threshold force, required for the haptic event from the selected haptic device to be fired and the resulting haptic response, e.g. acceleration, force etc., caused by the selected haptic device and the piezoelectric actuators therein. As mentioned earlier, the measuring sensors 3 must be able to move, in the same way a finger would when pressing the same haptic device to be able to measure an accurate threshold force and resultant acceleration. Current rigid universal test machines or dedicated measuring systems for mechanical switches are not suited to reproduce this behavior while measuring force feedback and acceleration.

Accordingly, the compliant element 4 may be provided on the probe 1, e.g. between the measuring sensors 3 and the mounting member 5, to enable the measuring sensors 3, e.g. the first and/or the second piezoelectric sensor elements 11 and 12, to move and sense the haptic response, e.g. acceleration, while forming the mechanical impedance and moving mass to substantially match a human finger. The compliant element 4 may have the following characteristics: 1) enables an adequate degree of compliance, e.g. stiffness between 1 N/mm and 10 N/mm and a damping between 0.5Ns/m and 1Ns/m, a Shore hardness of 30 OO to 80 OO, preferably 40 OO to 70 OO (or a Shore hardness of 0 A to 50 A, preferably 10 A to 40 A); 2) robust enough for a production environment; 3) adequate balance between cost and lifetime, e.g. >30 000 clicks/production day are expected, a situation in which the compliant element 4 needs to be changed every day but is not expensive may be acceptable; 4) sufficient data repeatability and accuracy, i.e. not significantly affect haptic signal clarity; and 5) a damping property between 0.5 Ns/m and 1 Ns/m.

Examples of suitable material may include: Sorbothane™, Viscoelastic polyurethane and Gyftane™, Urethane rubber with a Shore hardness between 30 OO and 80 OO, preferably between 40 OO and 70 OO, (or a Shore hardness of 0 A to 50 A, preferably 10 A to 40 A); and a thickness between 2 mm and 15 mm, preferably 2 mm and 7 mm.

Sorbothane™ elastomers are known for their vibration and acoustic isolation properties, their long fatigue life and low creep compared to other elastomer materials. They are used in many fields for vibration dampening and vibration isolation properties. Sorbothane is a viscoelastic polymer comprised of a thermoset, polyether-based, polyurethane material.

Sorbothane™ and Gyftane™ materials comprised of urethane rubber are available in a large range of hardness and can be cast to virtually any shape.

Accordingly, by configuring the compliant element 4 to be easily adaptable or replaceable by one or more other compliant element sections in a set 40 of compliant element sections 4′, 4″, 4″′ provided, some with one or more different properties, e.g. the mass, the spring constant, the dampening properties, the speed, the various properties of the compliant element 4, e.g. the mass, the spring constant, the dampening properties, the speed, can also be adjusted to enable specific haptic behaviors to be captured. Ideally, the moving mass of the probe 1 should be between 4 grams to 20 grams, which enables the probe 1 to move with the same mechanical impedance of a human finger. To facilitate interchanging of the compliant element 4 with one or more different compliant element sections, the compliant element 4 may include mechanical fasteners, one on each end thereof, for mating with corresponding mechanical fasteners on the measuring sensor 3 and the mounting member 5. In the example illustrated in FIG. 1A, the compliant element 4 includes female (or male) mechanical fasteners 25a and 25b extending into the top and bottom thereof for receiving male (or female) mechanical fasteners 26a and 26b extending from the measuring sensor 3 and the mounting member 5, respectively. The contact tip 2 may also include a first mechanical fastener 23a for mating with a second mechanical fastener 23b configured on the measuring sensor 3 to facilitate replacement thereof.

In another embodiment, illustrated in FIGS. 1B and 4, the mechanical fasteners comprise female (or male) mechanical fasteners 27 on the measuring sensor 3, the compliant element 4, and the mounting member 5, and a separate male (or female) mechanical fastener extending into or receiving the female (or male) mechanical fasteners 28. In another embodiment, illustrated in FIG. 1C, the mechanical fasteners comprise female (or male) mechanical fasteners 27 on the measuring sensor 3, the compliant element 4, and the mounting member 5, and a separate male (or female) mechanical fastener extending into or receiving the female (or male) mechanical fasteners 28.

In an exemplary embodiment, the compliant element 4 comprises an elastomeric disc 30, e.g. a soft viscoelastic polymer or rubber, sandwiched between first and second, e.g. threaded or adhesively bonded, interface plates 31 and 32. The upper interface plate 31 connected to the mounting member 5, and the lower interface plate 32 connected to the measuring sensors 3. The rubber disc 30 may have a stiffness between: 1 N/mm to 10 N/mm, may have a damping property between 0.5 Ns/m to 1 Ns/m, may have a diameter between 10 mm and 30 mm, preferably 15 mm to 20 mm, with a thickness of between 2 mm and 15 mm, preferably between 2 mm and 6 mm. The compliant element 4 enables the suspended sensor 3 to move independently from the arm 6 and the actuator 7, while forming the mechanical impedance and moving mass to substantially match a human finger. Examples systems for the actuator 7 include the Instron™ universal testing machine and the Mecademic Meca 500™ industrial robot arm.

In some embodiments, the contact tip 2 comprises a 3 mm to 15 mm, preferably 6 mm to 10 mm diameter contact surface to emulate a finger contact area. In an attempt to reproduce a finger's contact, an 8 mm diameter high density polyethylene (HDPE) or metal tip is preferred.

The probe 1, and in particular the compliant element 4, may have an influence on the acceleration amplitude and the force measured by the measuring sensors 3, but also on the length and frequency content of the haptic effect measured. Even though the goal is always to be as close as possible to the human arm and finger compliance, there are three major problems: 1) The perceived haptic feedback is subjective: different users can describe the same haptic feedback with different perceptions. 2) The probe 1 with the compliant element 4 is a simplified reproduction of the finger compliant system with inertia, stiffness and damping characteristics, while the human finger has variable rigidity and damping characteristics. Thus, it is currently not possible to replicate the exact same human finger system. Moreover, the exact characteristics, e.g. spring rate and damping, of a human finger will never be precisely measured, at least ethically, making the design of an instrumented replica quite challenging. 3) The observation of the haptic effect puts the measured system in series with the probe 1, changing the dynamic response characteristics.

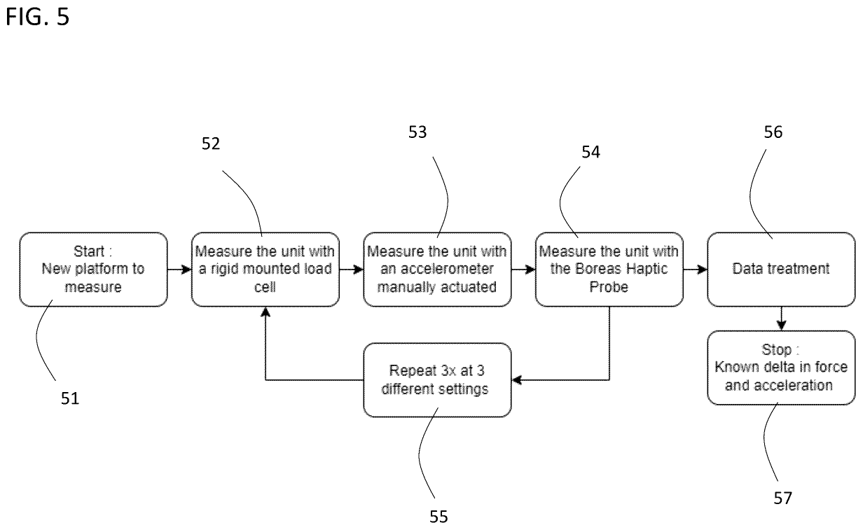

The following steps, illustrated in FIG. 5, are an attempt to correlate measurements between the probe 1 and a “closest approximation” measurement. Each time a new device is developed, the offsets may be established with the method shown, for each haptic intensity and force threshold. The correlation method may validate whether the offset between the measurements of the probe 1 and the “closest approximation” measurements is a constant, a linear function or a more complex function depending on the device, and then determine the correction factor to apply to results of the probe 1. A reason for using the probe 1 and going through the manual ‘’ closest approximation ‘’ process for each device is simply because the probe 1 has been found to be the best compromise of speed and useability in a production environment.

To measure dynamic events generated by a haptic device, i.e. a first dynamic system, a measurement system including a second dynamic system must be used. The two dynamic systems, placed in series, inevitably influence one another. Therefore, observing the first dynamic system implies change to the mechanical characteristics thereof to provide the observations. For example, two trackpads with different rigidities or moving masses could feel the same but have different force, e.g. threshold force, and haptic response, e.g. acceleration data. Inversely, they could be measured at a same force and acceleration but feel different due to the combination of their mechanical impedance and the haptic effect played. Accordingly, it is almost impossible to obtain the “real” values of force and acceleration since the measured values of acceleration (Gs) and force (grams) are heavily influenced by the measurement system.

With reference to FIG. 5, the “closest approximation” to the real values of force and acceleration may be given using a rigidly mounted load cell and a lightweight accelerometer bonded to the trackpad 19 and actuated by manually clicking on the trackpad 19. In other words, when the tested device changes, an offset between the closest approximation available and the values measured with the probe 1 may change. Even in the same device, e.g. a trackpad, if the mechanical characteristics vary greatly at different positions, it may be required to use a position-based offset. The controller processor 21 may determine the offset based on experimental data from rigidly mounted force sensor and manually actuated haptic measurements. When suitable offset factors are determined, the process is stopped, and actual testing of trackpad 19 may begin.

Accordingly an exemplary method of determining the offsets includes, a first step 51, which includes mounting the rigidly mounted load cell and the lightweight accelerometer on a test device, e.g. the trackpad 19 with the plurality of haptic devices, e.g. piezoelectric actuators 201 to 204, to be tested to obtain control force test data. Then, in step 52, an outside force applicator, e.g. the contact tip 2 of the probe 1, is brought into contact with the trackpad 19, which may be under manual control or under control of the controller processor 21 executing the computer instructions saved on the non-transitory memory 22. The force applied by the outside force application, e.g. the probe 1 via the contact tip 2, is increased until one or more of the piezoelectric actuators of the haptic device 19 reaches a threshold force, which causes a haptic response therefrom. The amount of force required to reach the threshold force is measured by the rigidly mounted load cell, e.g. the first piezoelectric sensor element 11 or the resistive load cell 41, and recorded by the controller processor 21 to be saved as control (force) test data in the non-transitory memory 22. Similarly, in step 53, the resultant haptic response from the one or more piezoelectric actuators of the haptic device 19 is measured by the sensor 3, e.g. the second piezoelectric sensor element 12 or the piezoelectric sensor 42 (accelerometer) and recorded by the controller processor 21 to be saved as control (acceleration) test data in the non-transitory memory 22.

Then, in step 54, to obtain probe force test data, the contact tip 2 of the probe 1 is brought into contact with the haptic device, e.g. trackpad 19, using the robotic arm 8 of the actuator 7 at a predetermined and desired speed, which may be under manual control or under control of the controller processor 21 executing computer instructions saved on the non-transitory memory 22. The force applied by the probe 1, via the contact tip 2 is increased until one or more of the piezoelectric actuators of the haptic device 19 reaches a threshold force, which causes a haptic response therefrom. The amount of force required to reach the threshold force is measured by, e.g. the first piezoelectric sensor elements 11 or the resistive load cell 41, in the sensor 3 and recorded by the controller processor 21 to be saved as probe (force) test data in the non-transitory memory 22. Simultaneously, the resultant haptic response from the haptic device 19, e.g. one or more piezoelectric actuators, is measured by, e.g. the second piezoelectric sensor elements 12 or the piezoelectric sensor 42, in the sensor 3, and recorded by the controller processor 21 to be saved as probe (acceleration) test data in the non-transitory memory 22.

Steps 52, 53 and 54 may be repeated (Step 55) a plurality of times, e.g. 3 to 10 times, at a plurality of different settings, e.g. a different setting each of the plurality of times. In step 56, the control (force) test data is compared to the probe (force) test data to determine a force offset factor, and the control (acceleration) test data is compared to the probe (acceleration) test data to determine an acceleration offset factor. When suitable force offset factor and acceleration offset factor are determined, the process is stopped (step 57), and actual testing of the haptic devices, e.g. trackpads, may begin.

The press speed of the contact tip 2 on the trackpad 19 is a parameter that contributes a great deal on the force and the acceleration exact value but also on the repeatability of the measurements. At low speed, the force measurements are not accurate relative to the control measured values illustrated in dashed lines, which is due to the utilization of the dynamic sensor 3, i.e. in a quasi-static situation. However, a stabilization of the force measurements happens at greater than or equal to about 7 mm/s and force thresholds around 192 gr for a first piezoelectric actuator (Piezo 1) and 180 gr for a second piezoelectric actuator (Piezo 2) are observed, resulting in an offset of about 25 gr between the sensor 3 and the rigid mounted load cell.

The desired press speed for the probe 1, e.g. using the Mecademic Meca500™ robot arm, was set to above about 6 mm/s, preferably above about 7 mm/s, more preferably between about 7 mm/s and 10 mm/s, and even more preferably about 7 mm/s. The speed of about 7 mm/s offers many advantages: force measurements are stable; good repeatability; and shorter test time. Other press speeds, such as 0.5 mm/s to 15 mm/s, preferably 0.5 mm/s to 7 mm/s, depending on the probe 1 and the sensors 3, are within the scope of the invention.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. A test probe for a haptic device configured for mounting on a moveable structure, comprising:
a contact tip configured for contacting the haptic device;
a sensor configured for measuring a threshold force of the haptic device, and a haptic response characteristic of a resulting haptic response thereof at substantially a same time and substantially a same location;
a compliant element configured for enabling the sensor to move relative to the haptic device; and
a mounting member configured for mounting the testing probe on the moveable structure.

2. The test probe according to claim 1, wherein the sensor comprises a resistive load cell or a piezoelectric element configured for measuring the threshold force, and a piezoelectric sensor configured for measuring the haptic response characteristic.

3. The test probe according to claim 1, wherein the compliant element includes an elastomeric disc with a stiffness of between 1 N/mm to 10 N/mm.

4. The test probe according to claim 3, wherein the elastomeric disc is configured to provide a damping property of between 0.5 Ns/m to 1 Ns/m.

5. The test probe according to claim 1, wherein the compliant is configured to provide a damping property of between 0.5 Ns/m to 1 Ns/m.

6. The test probe according to claim 1, wherein the compliant element is sandwiched between first and second interface plates.

7. The test probe according to claim 1, wherein the haptic characteristic is selected from the group consisting of strength of the haptic effects, duration, and frequency.

8. The test probe according to claim 1, wherein the haptic characteristic comprises displacement or derivatives of displacement.

9. The test probe according to claim 1, further comprising a set of compliant element sections, some with one or more different properties, selected from the group consisting of mass, a spring constant, and a dampening property, configured for adjusting the mass, the spring constant, and the dampening property of the compliant element to enable specific haptic behaviors to be captured.

10. A testing system for a haptic device, comprising:
a moveable structure;
a test probe configured for mounting on the moveable structure comprising:
a contact tip configured for contacting the haptic device;
a sensor configured for measuring a threshold force of the haptic device, and a haptic response characteristic of a resulting haptic response of the haptic device at a same time and a same location; and
a compliant element configured for enabling the sensor to move relative to the haptic device;
a controller processor; and
a non-transitory memory storing instructions, which when executed by the controller processor directs the test probe to contact the haptic device.

11. The testing system according to claim 10, wherein the controller processor converts electrical signals from the sensor into a corresponding force measurement and a corresponding haptic response characteristic measurement; and wherein the controller processor adds a force offset to the force measurement, and adds a haptic characteristic offset to the haptic response characteristic measurement.

12. The testing system according to claim 11, wherein the controller determines the force offset and the haptic response characteristic offset based on experimental data from independent sensors for the fixed force and the haptic response characteristic.

13. The test system according to claim 10, wherein the sensor comprises a resistive load cell or a piezoelectric element configured for measuring the threshold force, and a piezoelectric sensor element configured for measuring the haptic response characteristic.

14. The test system according to claim 10, wherein the compliant element includes an elastomeric disc with a stiffness of between 1 N/mm to 10 N/mm.

15. The test system according to claim 14, wherein the elastomeric disc is configured to provide a damping property of between 0.5 Ns/m to 1 Ns/m.

16. The test system according to claim 10, wherein the compliant element is sandwiched between first and second interface plates.

17. The test system according to claim 10, wherein the compliant element is configured to provide a damping property of between 0.5 Ns/m to 1 Ns/m.

18. The test system according to claim 10, wherein the haptic response characteristic is selected from the group consisting of strength of the haptic effect, duration, velocity and frequency.

19. The test system according to claim 10, wherein the haptic response characteristic is displacement, velocity or acceleration.

20. The test system according to claim 10, further comprising a set of compliant element sections, some with one or more different properties, selected from the group consisting of mass, a spring constant, and a dampening property, configured for adjusting the mass, the spring constant, and the dampening property of the compliant element to enable specific haptic behaviors to be captured.
